(19) United States
(12) Patent Application Publication
(10) Pub. No.: US 2005/0177413 A1
(43) Pub. Date: Aug. 11, 2005

(54) Method and system for measuring web site impact

(76) Inventors: Marc Andrew Blumberg, Dallas, TX (US); Dawn Marie Gardetto, Irving, TX (US); Douglas Alan Levy, Dallas, TX (US); James Pietz, Flower Mound, TX (US); Tim Rumpler, Irving, TX (US); Ian Wolfman, Dallas, TX (US)

Correspondence Address: Daniel H. Golub, 1701 Market Street, Philadelphia, PA, 19103, US

(21) Appl. No.: 10/778,615

(22) Filed: Feb. 11, 2004

(51) Int. Cl. G06F 17/60

(52) U.S. Cl. 705/10

(57) ABSTRACT

The impact of a web site on an intent of a web site viewer to take a desired action relating to a product or service is measured. The web site includes a collection of web pages that display information relating to the product or service. The viewer is presented with a plurality of questions related to the web site. At least one of the questions is presented upon the viewer exiting the web site. A response to at least some of the plurality of questions is received from the viewer. Based on the response, a metric is calculated, indicating the impact.

### FIELD OF THE INVENTION

The present invention relates to measuring a Web site's impact on a viewer's intent to take a desired action with respect to the product or service that is the subject of the Web site.

### BACKGROUND OF THE INVENTION

Brand marketers are responsible for allocating marketing budgets to the tactics most likely to result in sales growth. They determine the mix of funding allocated to TV campaigns, print ads, Internet sites, or other marketing programs. For years, brand marketers have been trying to assess the degree to which the Web sites they create lead to incremental sales. They are frustrated because they are unable to determine how effective their investment in a Web site is at driving revenue. The metrics they are currently able to obtain, such as the number of site visitors, what pages are most popular, and what users think of the site, fail to address the critical question of brand managers, namely, does my Web site change my target audience's intent to buy. Thus, there exists a need for a way to assess the likelihood that a visit to a Web site will increase sales.

There are several prior art products that are designed to assess the usability of Web sites. These products focus on determining the effectiveness of aspects of the site (such as organization, navigation, and content) on influencing site visitors. One such product intercepts site visitors and collects a database of responses to questions about usability. This product scores sites on the site's success in meeting usability standards. Another product sends visitors to a site to conduct market research. None of these tools provide for measurement of the impact of a site on a visitor's plan to take action. Also, none use an exit survey methodology, quantify the propensity of a site to impact purchase behavior, or offer an analysis of a given site in comparison to other sites as it relates to change in purchase intent.

Other prior art products include log file analysis tools, which provide basic information on server usage. These products dissect log files, which are data stores automatically generated by sites to monitor file requests. The software provides user-friendly summary reports that show site usage trends, such as the number of visitors at various times, where site visitors come from, and what pages were viewed. However, these products also do not address the question of how successful sites are at changing the opinions and buying behaviors of visitors.

Another class of prior art tools invite users to provide input on Web pages and sites. Typically, users click on a button at the bottom of the page to give a rating. Web developers and brand marketers use that rating to gauge satisfaction with particular pages. This methodology focuses simply on whether users like pages, not whether the site experience impacts purchase intent. It also fails to capture information about the user's reason for visiting, status, or purchase intent prior to visiting the site.

### SUMMARY OF THE INVENTION

The present invention is directed to a method and system for measuring an impact of a web site on an intent of at least one web site viewer to take a desired action relating to a product or service. The web site comprises a collection of web pages that display information relating to the product or service. The viewer is presented with a plurality of questions related to the web site. At least one of the questions is presented upon the viewer taking an action indicating an intent to cease viewing any of the collection of web pages. A response to at least some of the plurality of questions is received from the viewer. A metric is calculated, based on the response, indicating the impact.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide further understanding of the invention and are incorporated in and constitute a part of this specification, illustrate embodiments of the invention and, together with the description, serve to explain the principles of the invention.

In the drawings:

FIG. 1 illustrates a preferred embodiment of a system for carrying out the present invention.

FIGS. 2A and 2B illustrate exemplary screens that may be used in connection with the present invention.

FIGS. 3A and 3B illustrate an exemplary entry question set.

FIGS. 4A and 4B illustrate an exemplary exit question set.

FIGS. 5A, 5B, 5C and 5D illustrate portions of exemplary reports generated in accordance with the present invention.

FIGS. 6A and 6B illustrate portions of exemplary reports generated in accordance with the present invention.

FIG. 7A illustrates an exemplary follow up e-mail sent to survey respondents in accordance with the present invention and FIG. 7B illustrates exemplary follow up survey questions.

FIGS. 8A and 8B are flow charts illustrating steps of a method of the present invention.

### DETAILED DESCRIPTION OF THE PREFERRED EMBODIMENTS

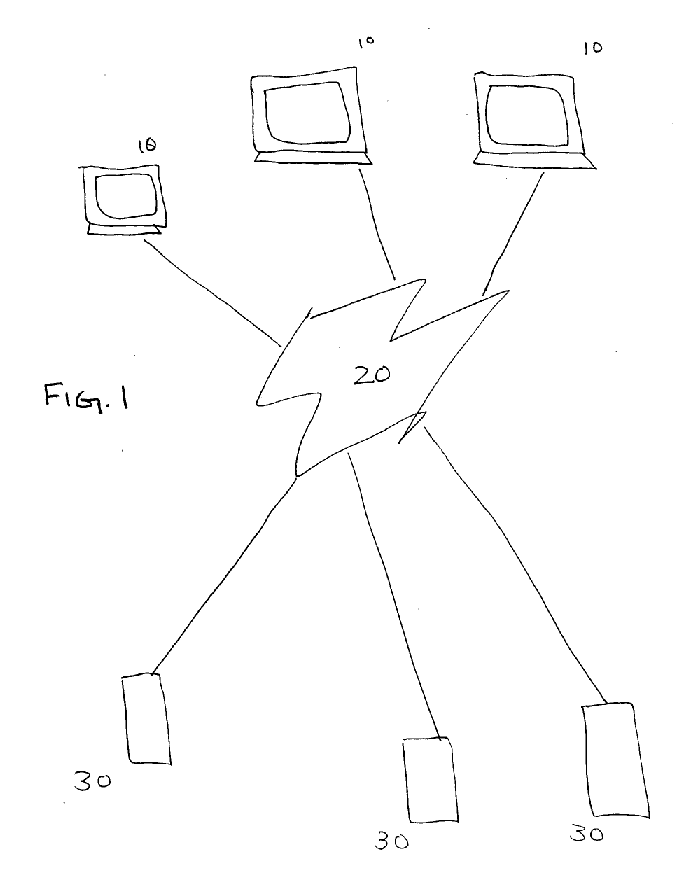

FIG. 1 illustrates a preferred embodiment of a system 100 for carrying out the present invention. One or more client machines 10 are connected over a network 20, such as the Internet, allowing viewers at the client machines 10 to view Web pages hosted on one or more servers 30. Collections of related Web pages that display to a viewer information relating to products or services are referred to herein as a Web site.

In accordance with the present invention, visitors to a Web site are presented with, and respond to, one or more questions from a survey during their visit to the Web site. In the preferred embodiment, the Web site viewer receives one or more questions from the survey upon his entering the Web site and again upon taking an action indicating his intent to exit the Web site. The particular viewers selected to receive an invitation to participate in the survey are chosen randomly in accordance with a predetermined ratio (e.g., every one of three visitors receives an invitation to participate in the survey), in the preferred embodiment.

The following example illustrates a survey conducted with respect to a Web site that provides information about a drug. While the illustrated survey is designed for a Web site relating to a particular kind product (i.e., a drug), the present invention can be used in connection with Web sites relating to any type of product or service.

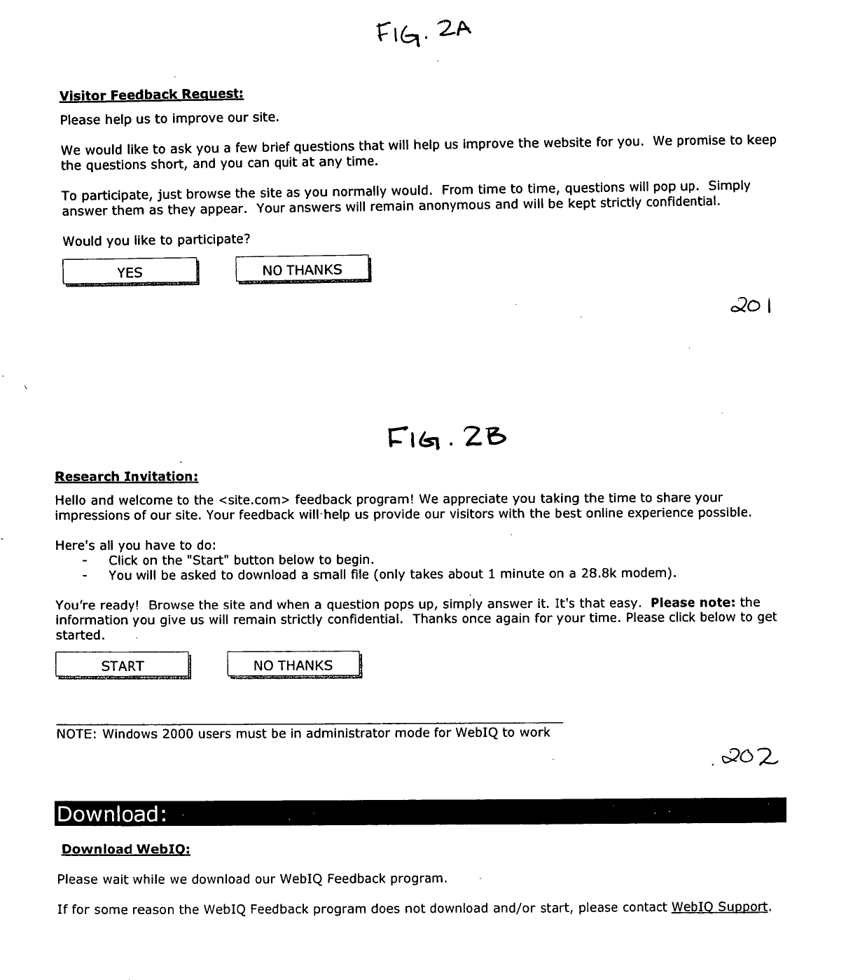

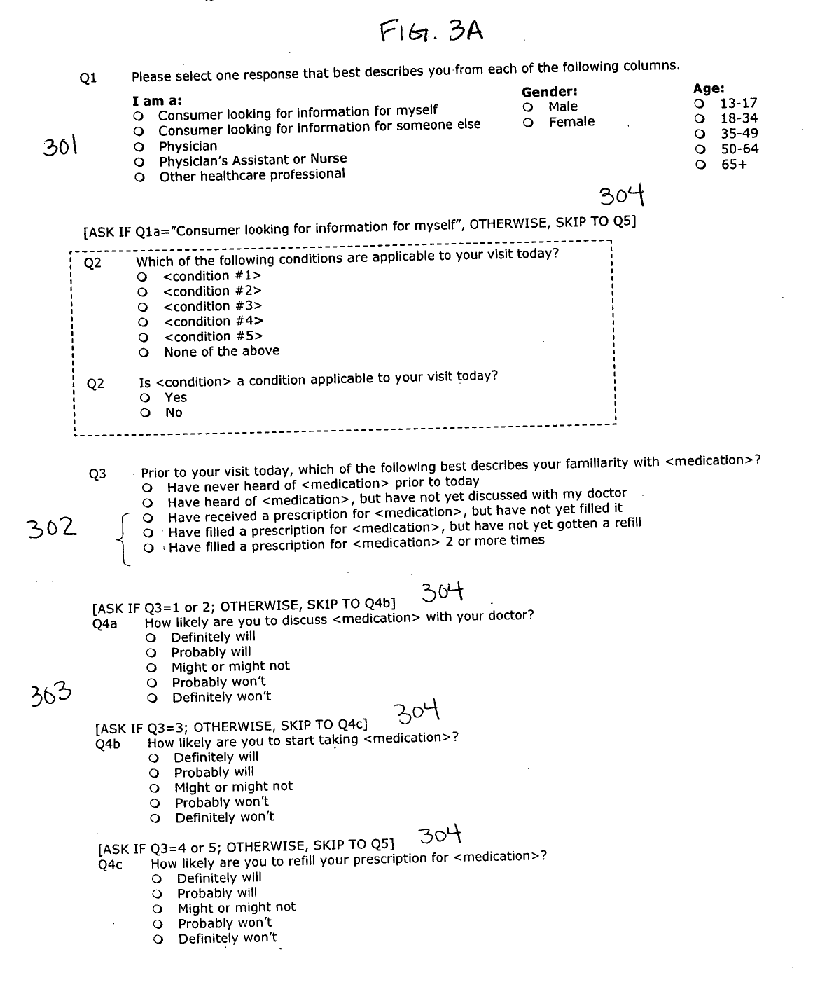

Referring to the exemplary screens of FIGS. 2A and 2B, the Web site viewer may be asked in screen 201 if he is interested in participating in the survey. If he agrees to participate, he may be given some preliminary instructions in screen 202 and asked to download a program to client machine 10, which is used to implement the survey. In one embodiment, Web IQ software, a product of Usability Sciences Corporation, is used to intercept the survey responses. Web IQ is software that facilitates the interception of Web site viewers' responses via JavaScript programming. The intercept message invites viewers to download and install an ActiveX application that then presents survey questions, collects responses, and collects data about the site visit (i.e., pages visited). However, other methods of collecting the survey responses are known in the art and can be used in connection with the present invention.

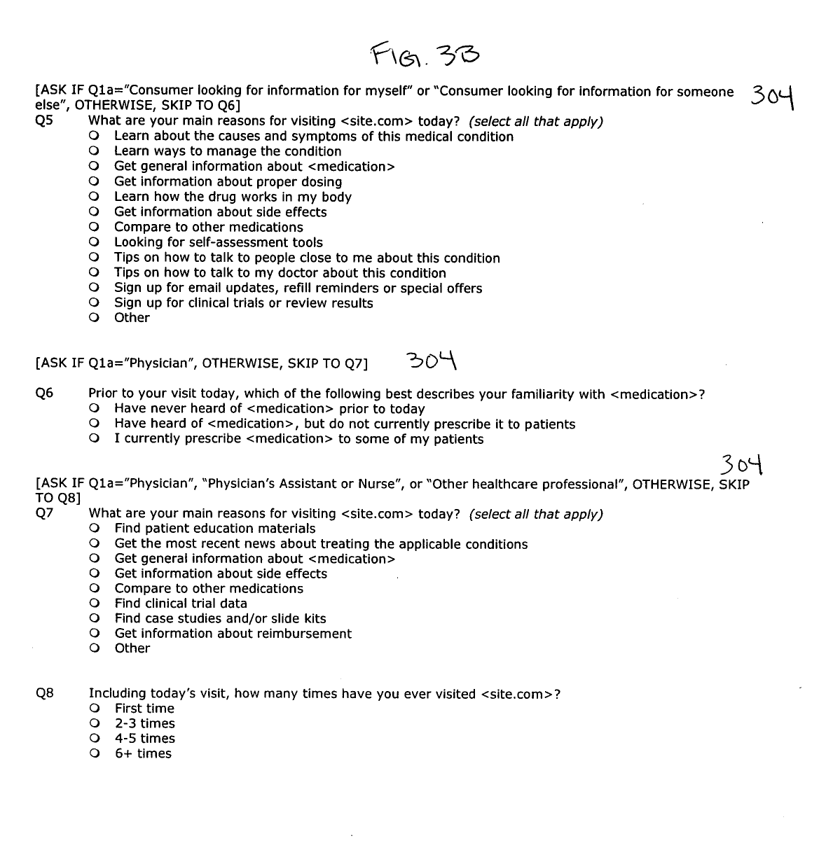

FIGS. 3A and 3B illustrate an exemplary set of entry questions that may be displayed to viewers upon their entering a Web site. Also shown are question selection logic statements 304 that dictate which questions are presented to the viewer, based on the viewer's responses to previously presented survey questions. Some preliminary questions 301 seeking basic demographic information about the viewer, such as the viewer's gender and age, as well as a viewer categorization question, may be presented. In the preferred embodiment, the viewer is presented with one or more questions 302 about his stage of product or service adoption (e.g., from never having heard of the product or service to being a frequent user of the product or service). The entry question set also includes questions 303 relating to the viewer's intent with respect to use or purchase of the product or service, measured upon his entering the Web site. For example, these questions may explore whether a viewer who had never heard of a drug discussed on the Web site upon entering the Web site intended to talk to his health care professional about the drug. Similarly, these questions may explore whether a viewer who was currently taking the drug intended to renew his prescription for the drug. In the preferred embodiment, the particular questions 303 presented to the viewer are chosen based on the viewer's stage of product or service adoption, as indicated in response to question 302.

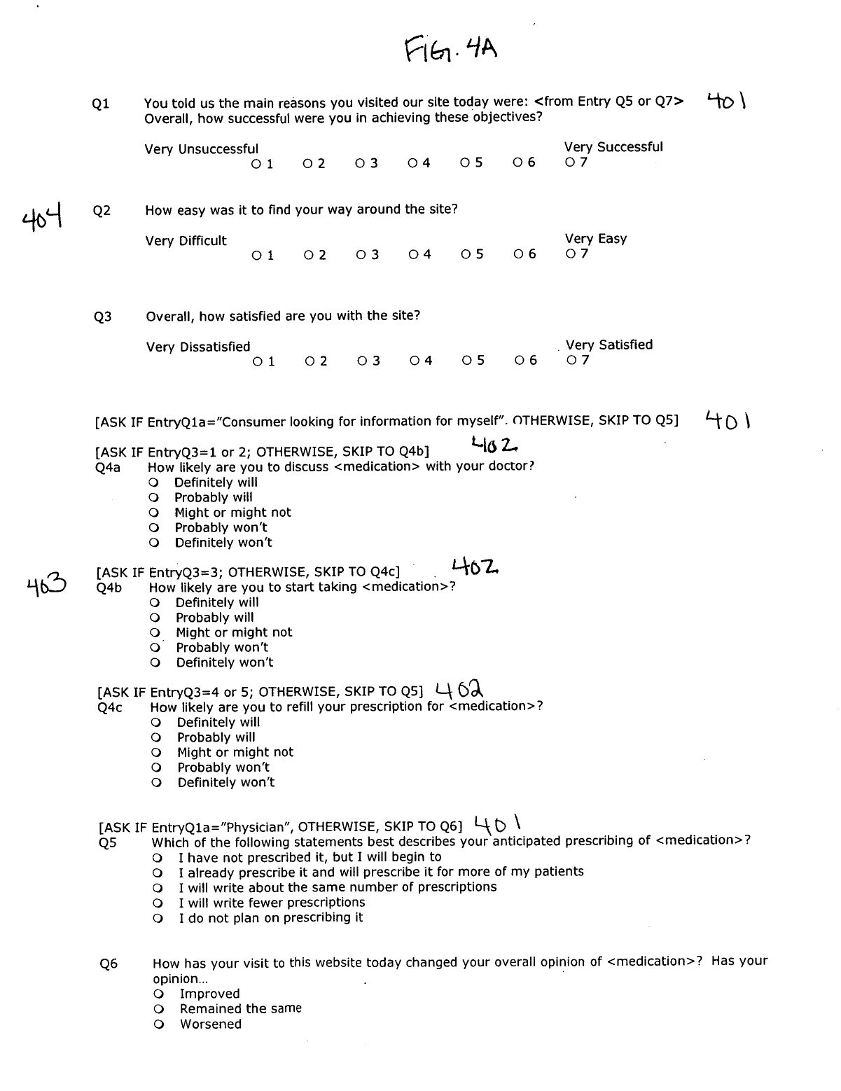

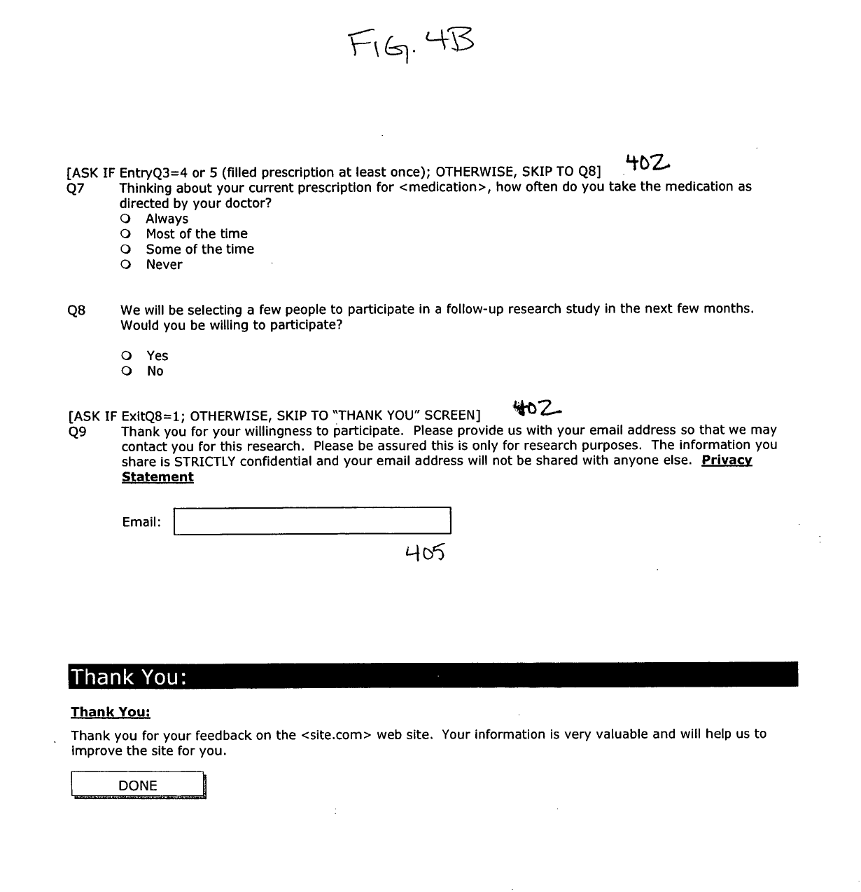

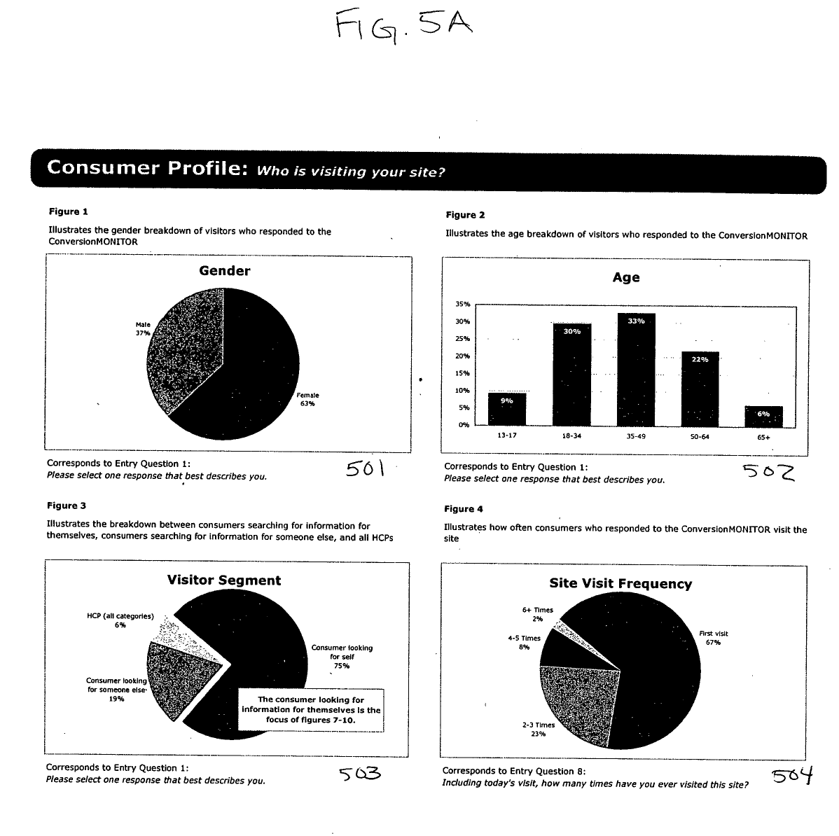

FIGS. 4A and 4B illustrate an exemplary set of exit questions that are presented to a viewer upon the viewer's taking some action indicating his intent to exit the Web site. The specific questions presented upon exit may be based on or tailored to answers of the viewer in response to one or more of the entry questions (shown in FIGS. 3A and 3B), as indicated by question selection logic statements 401. In addition, the viewer's answers to certain of the questions in the exit question set may dictate the questions presented to the viewer later on in the survey, as illustrated by logic statements 402. In the preferred embodiment, questions 403 are presented as part of the exit question set, which relate to the viewer's intent with respect to use or purchase of the product or service upon exiting the Web site. In the preferred embodiment, the particular questions 403 presented to the viewer are chosen based on the viewer's stage of product or service adoption. Questions 404 may also be included, directed to the viewer's opinions on the Web site's usability. The viewer is preferably asked to include his contact information 405 upon exit to allow for gaining additional information from the viewer with regard to the survey at a later date.

In the preferred embodiment, certain of the questions in entry question set and exit question set must be answered by the viewer in order to allow for a complete analysis of the survey response in accordance with the present invention. If all of the required questions are not answered, the viewer will be prompted to provide responses to these questions before exiting the survey.

Survey results must be gathered from a statistically relevant number of viewers for a given Web site in order to perform a meaningful analysis of the results. In one embodiment of the invention, approximately 200 surveys should be completed for a meaningful analysis to be performed.

Upon gathering the survey responses, the data can be analyzed in accordance with the methods of the present invention. In particular, in the preferred embodiment, for each stage of product or service adoption, the percentage of survey respondents who indicate their intent to take a desired action with respect to the product or service is determined both at entry to the Web site and upon exit.

For example, assume that surveys were completed by 1000 visitors to a Web site. Of the 1000 visitors, 400 of the visitors, or 40%, had never heard of the product that was the subject of the Web site, in this case, a drug. Upon entering the site, 100 of the visitors in this category, or 25%, indicated that they would discuss the drug with their health care professional (i.e., an action of visitors in this category desired by the Web site host, the drug company). Upon exiting the Web site, 300 of the visitors in this category, or 75%, indicated that they would discuss the drug with their health care professional. Of the 1000 visitors to the Web site, 300 of the visitors, or 30%, had a prescription for the drug, but had not had it filled. Upon entering the site, 100 of the visitors in this category, or 33%, indicated that they would start taking the drug (i.e., an action of visitors in this category desired by the drug company). Upon exiting the Web site, 200 of the visitors in this category, or 66%, indicated that they would start taking the drug. Of the 1000 visitors to the Web site, 300 of the visitors, or 30%, had a prescription for the drug and had refilled it at least once. Upon entering the site, 250 of the visitors in this category, or 83%, indicated that they would refill the prescription (i.e., an action of visitors in this category desired by the drug company). Upon exiting the Web site, 300 of the visitors in this category, or 100%, indicated that they would refill the prescription.

A weighted average of these percentages is then calculated to arrive at a metric which quantifies the impact of the Web site on changing the propensity of a Web site viewer to take a desired action with regard to the product or service. For example, upon entry to the Web site, 44.8% of the Web site viewers were likely to take a desired action with respect to the drug (namely, (0.40*0.25)+(0.30*0.33)+(0.30*0.83)). Upon exiting the Web site, 79.8% of the Web site viewers were likely to take a desired action with respect to the drug (namely, (0.40*0.75)+(0.30*0.66)+(0.30*1.0)). Thus, the impact of the Web site on changing the propensity of the viewer to take a desired action for the drug is 78% (namely, (79.8%−44.8%)/44.8%).

The survey data and results of the analysis performed on this data can be summarized and conveyed by way of one or more reports. FIGS. 5A, 5B, 5C and 5D show portions of an exemplary report generated in accordance with the present invention reflecting data gathered from consumer survey respondents visiting the Web site under investigation. In particular, FIG. 5A illustrates graphs 501 and 502, which provide demographic information, such as gender and age, for visitors to the Web site. Graph 503 illustrates the number of survey respondents in different categories (i.e., health care professionals or consumers, looking for information on the Web site for himself or someone else). Graph 504 provides information regarding the frequency with which the Web site respondents visit the Web site. FIG. 5B provides information by way of graph 505 regarding the visitors' stated objectives in visiting the Web site. Graphs 506 provide information regarding whether the stated objectives were achieved and other information regarding the usability of the Web site.

FIG. 5C illustrates the effectiveness of the Web site in moving visitors along the consumer action continuum. In particular, graph 507 defines groups of survey respondents based on their relationship with the product prior to the visit to the Web site and associates each group with an opportunity for the Web site to influence a desired action. Graph 508 illustrates the survey respondents' intent to take a desired action upon entry to the Web site and again upon exiting the Web site. Referring to FIG. 5D, graph 509 illustrates the impact of the visit to the Web site upon the survey respondents' opinion of the product. Graph 510 illustrates the metric, referred to herein as conversion lift, indicating the influence of a Web site on motivating consumers to take desired actions along the consumer action continuum.

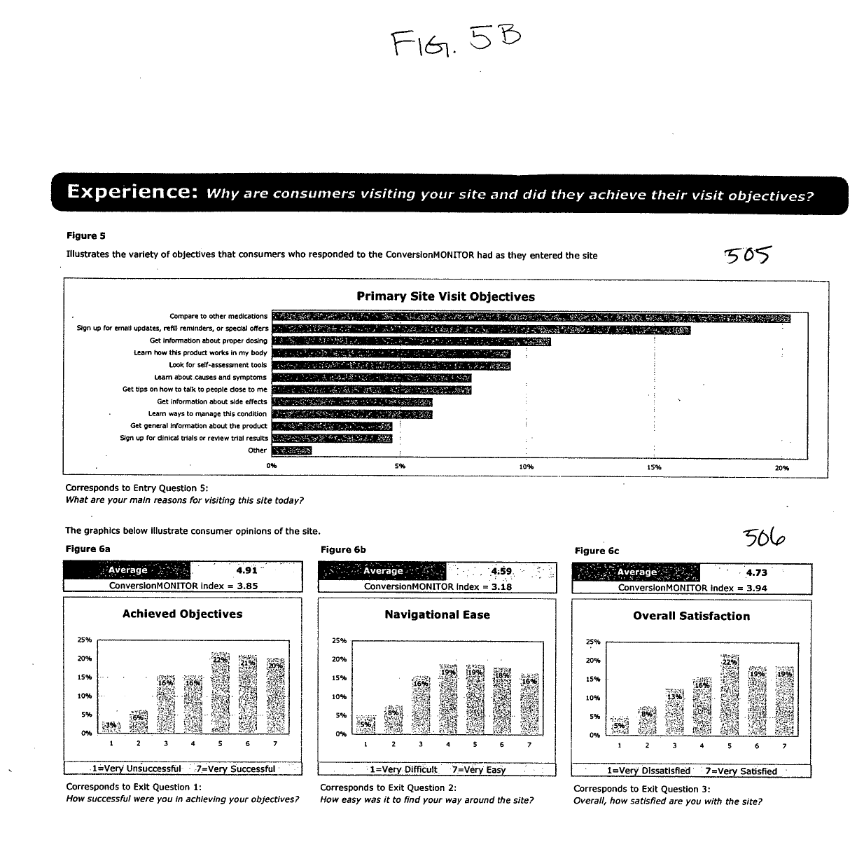

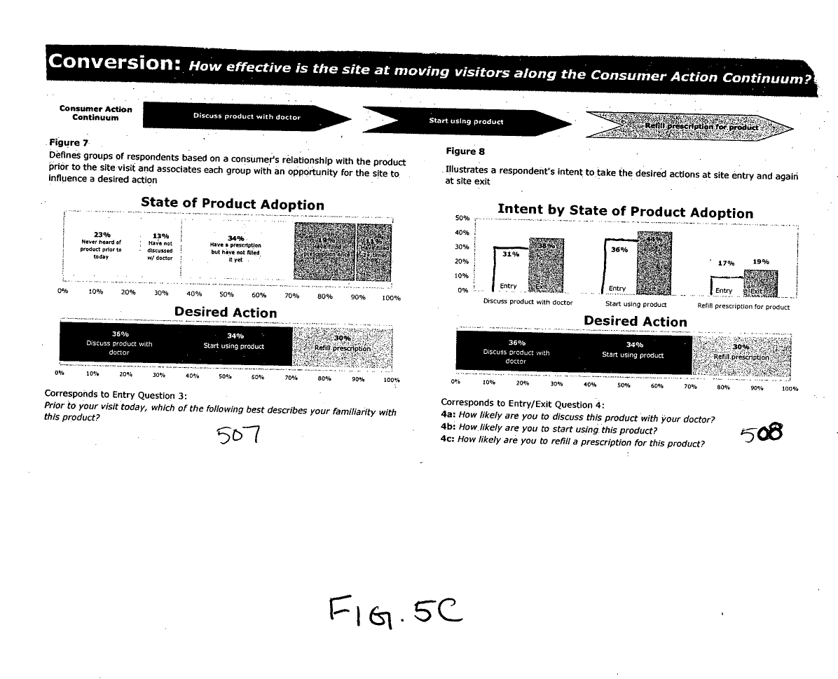

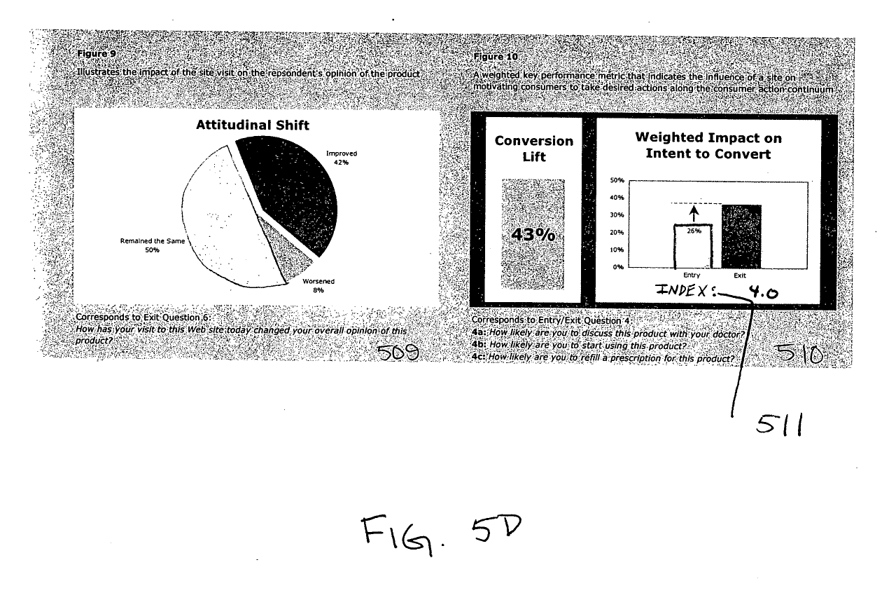

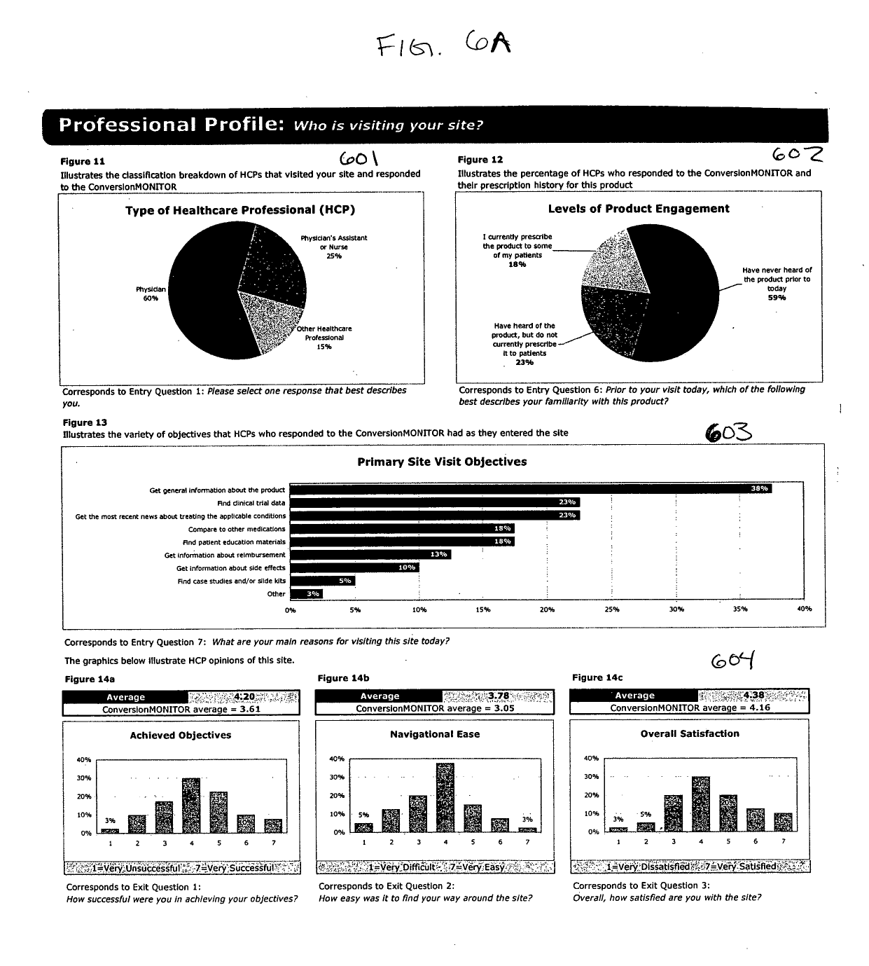

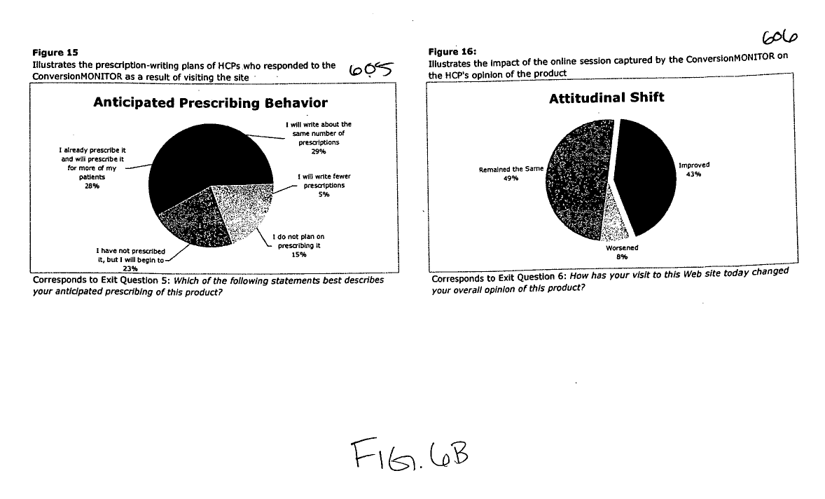

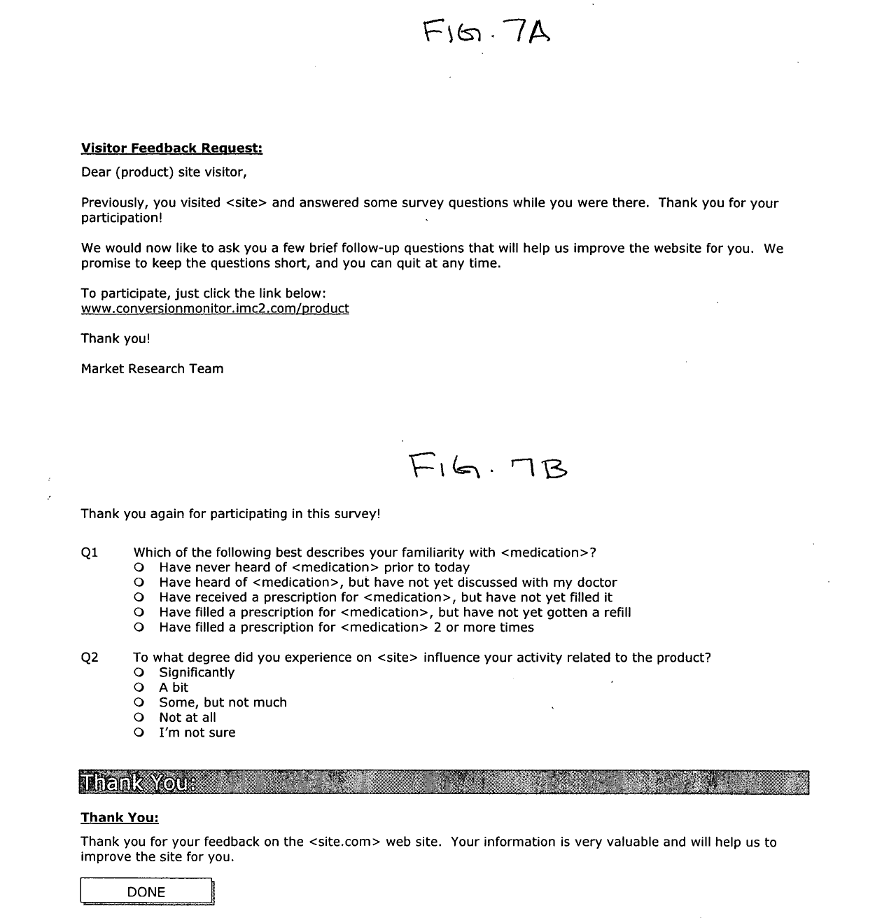

Similarly, FIGS. 6A and 6B show portions of an exemplary report generated in accordance with the present invention reflecting data gathered from professional respondents visiting the Web site under investigation. Graph 601 of FIG. 6A provides information regarding the type of professionals responding to the survey. Graph 602 provides information regarding the professionals' involvement with the product that is the subject of the Web site. Graph 603 provides information relating to the professionals' stated objective in visiting the Web site and graphs 604 convey information describing the professionals' opinions regarding usability of the Web site. Referring to FIG. 6B, graph 605 illustrates the anticipated behavior of the professionals as it relates to the product as a result of visiting the Web site. Finally, graph 606 illustrates the shift of attitude of the professionals toward the product as a result of visiting the Web site.

In the preferred embodiment, the reports also compare the Web site's conversion lift to a normative database of other similar sites. This might be represented as an index 511, as illustrated in FIG. 5D.

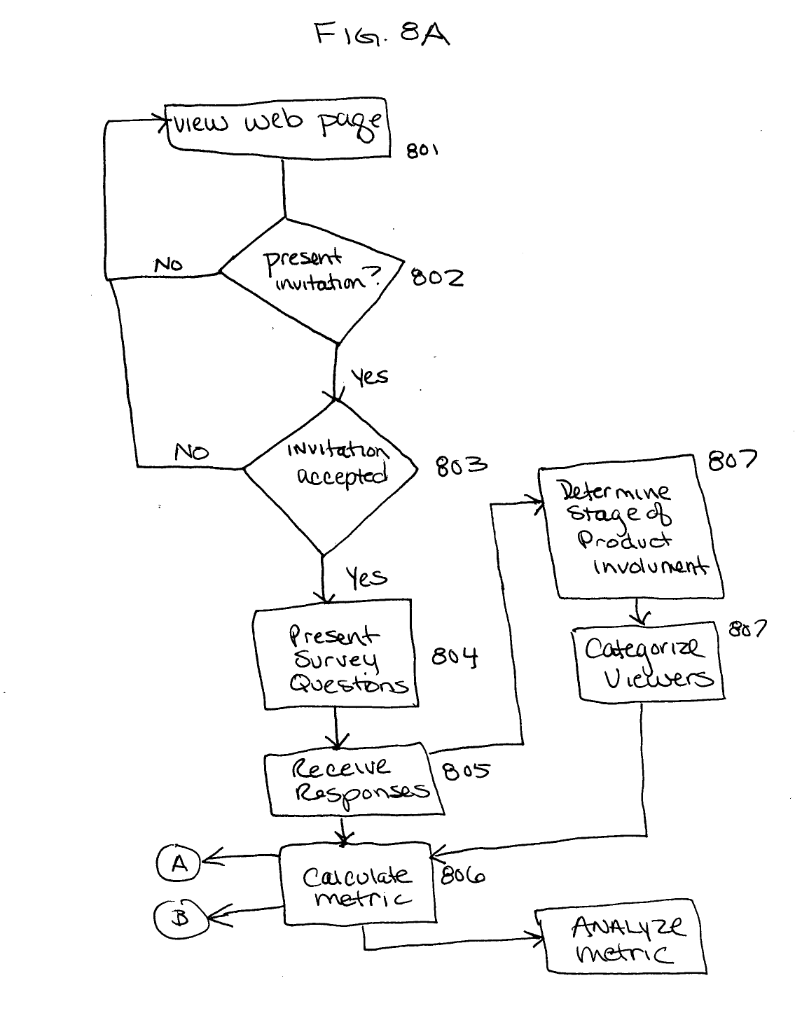

At periodic intervals after responding to the survey, follow up e-mails may be sent to survey respondents to determine how the respondent's intended behavior and reported behavior with respect to the product or service compared with the intended behavior the survey respondent reported in response to the exit question set. For example, with reference to FIG. 7A, an exemplary follow-up e-mail is illustrated. FIG. 7B illustrates exemplary follow up questions.

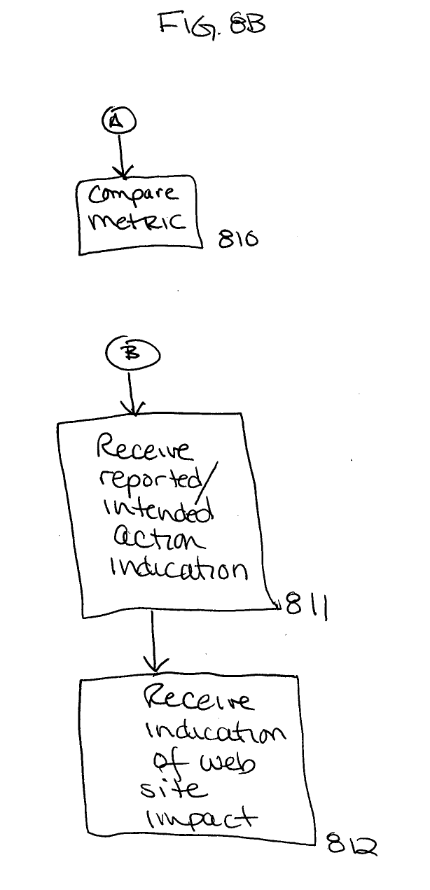

FIG. 8A is a flow chart illustrating a method for measuring an impact of a web site on an intent of a web site viewer to take a desired action relating to a product or service, in accordance with a preferred embodiment of the present invention. In step 801, the viewer views one or more pages from the Web site. In step 802, it is determined whether the viewer should be presented with an invitation to take the survey. If so, it is determined, in step 803, whether the viewer has accepted the invitation. If the viewer accepts the invitation, in step 804, the viewer is presented with a plurality of questions related to the Web site. At least one of the questions is presented upon the viewer taking an action indicating an intent exit the Web site. In step 805, a response to at least some of the plurality of questions is received from the viewer. In step 806, a metric, indicating the impact, is calculated based on the response.

In the preferred embodiment, in step 807, a stage of involvement with the product or service is determined for each of the viewers. In step 808, the viewers are categorized based on the determined stage of involvement and, in step 809, the metric is analyzed for each category of viewers.

With reference to FIG. 8B, in some embodiments, in step 810, the metric is compared to a plurality of other metrics calculated for a plurality of other web sites, relating to products or services, indicating an impact of the other web sites on an intent of viewers of the web sites to take a desired action relating to the products or services.

In some embodiments, in step 811, after the viewer exits the Web site, an indication of a reported or an intended action of the viewer relating to the product or service is received from the viewer. In further embodiments, in step 812, an indication of whether the viewer's reported or intended action relating to the product or service was impacted by the viewer's viewing the Web site is received from the viewer.

1. A method for measuring an impact of a web site on an intent of at least one web site viewer to take a desired action relating to a product or service, wherein the web site comprises a collection of web pages that display information relating to the product or service, comprising:
presenting to the viewer a plurality of questions related to the web site, wherein at least one of the questions is presented upon the viewer taking an action indicating an intent to cease viewing any of the collection of web pages;
receiving from the viewer a response to at least some of the plurality of questions; and
calculating a metric, based on the response, indicating the impact.

2. The method of claim 1, wherein at least one of the questions is presented to the viewer upon the viewer taking an action indicating an intent to commence viewing at least one of the web pages.

3. The method of claim 1 further comprising:
comparing the metric to a plurality of other metrics calculated for a plurality of other web sites, relating to products or services, indicating an impact of the other web sites on an intent of viewers of the web sites to take a desired action relating to the products or services.

4. The method of claim 1 further comprising:
determining, for each of the viewers, a stage of involvement with the product or service;
categorizing the viewers based on the stage of involvement with the product or service; and
analyzing the metric for each category of viewers.

5. The method of claim 1, wherein the plurality of questions relate to at least one of: a stage of involvement with the product or service for the viewer; a likelihood the viewer will use or purchase the product or service; a likelihood the viewer will use or purchase more of the product or service; viewer demographic information; a reason for visiting the web site; an opinion on usability of the web site; and an opinion on success of the web site.

6. The method of claim 1 further comprising:
receiving from the viewer, after the viewer ceases viewing the collection of web pages, an indication of a reported action of the viewer relating to the product or service.

7. The method of claim 1 further comprising:
receiving from the viewer, after the viewer ceases viewing the collection of web pages, an indication of an intended action of the viewer relating to the product or service.

8. The method of claim 6 further comprising:
receiving from the viewer an indication of whether the viewer's reported action relating to the product or service was impacted by the viewer's viewing the web site.

9. The method of claim 7 further comprising:
receiving from the viewer an indication of whether the viewer's intended action relating to the product or service was impacted by the viewer's viewing the web site.

10. A system for measuring an impact of a web site on an intent of at least one web site viewer at a workstation to take a desired action relating to a product or service, wherein the web site comprises a collection of web pages that display information relating to the product or service, comprising:
one or more servers for presenting to the viewer at the workstation a plurality of questions related to the web site, wherein at least one of the questions is presented upon the viewer taking an action indicating an intent to cease viewing any of the collection of web pages; receiving from the viewer a response to at least some of the plurality of questions; and calculating a metric, based on the response, indicating the impact.
